(19) United States
(12) Patent Application Publication
(10) Pub. No.: US 2011/0031712 A1
(43) Pub. Date: Feb. 10, 2011

(54) REAR AXLE OF TYPE TWIST BEAM AXLE FOR MOTOR VEHICLE

(75) Inventors: Gerd BITZ, Mainz (DE); Michael HARDER, Bodenheim (DE); Dirk EHRLICH, Bodenheim (DE); Jüergen SIEBENEICK, Oberwesel (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/830,199

(22) Filed: Jul. 2, 2010

(30) Foreign Application Priority Data
Jul. 3, 2009 (DE) 102009031846.1

(51) Int. Cl. B60G 21/05

(52) U.S. Cl. 280/124.106

(57) ABSTRACT

A twist beam axle is provided for a motor vehicle, with two rigid trailing arms for the mounting of wheel carriers, each of which can be articulated on a vehicle body through a bearing bush. The trailing arms are connected with each other through a flexurally rigid, but at least in sections, torsionally elastic, antiroll bar and through a Watt's linkage. In the twist beam axle, center axes of the bearing bushes are each arranged parallel to the vehicle vertical axis. In addition, the invention extends to a motor vehicle equipped with such a rear axle.

### CROSS-REFERENCE TO RELATED APPLICATION

This application claims priority to German Patent Application No. 102009031846.1, filed Jul. 3, 2009, which is incorporated herein by reference in its entirety.

### TECHNICAL FIELD

The present invention is in the area of vehicle engineering and generically relates to a motor vehicle rear axle of type twist beam axle and to a motor vehicle equipped with such a rear axle.

### BACKGROUND

Twist beam rear axles are thoroughly known to the persons skilled in the art of chassis engineering. They are used in series production of modern motor vehicles since they combine advantageous driving characteristics with a simple technical construction. In general, rear axles of the twist beam axle type, which are termed “twist beam axles,” comprise two rigid trailing arms that are provided with fastening sections for fastening wheel carriers for the rotatable mounting of vehicle wheels. At their front end the two trailing arms are articulated on the vehicle body or a bogie connected with the vehicle body via bearing bushes. The two trailing arms are connected with each other through a flexurally stiff yet torsionally soft antiroll bar. The antiroll bar acts as stabilizer so that when traveling through a curve the road holding of the vehicle can be substantially improved. The stabilizer effect of the antiroll bar can be amplified through an additional stabilizer. Twist beam axles are thoroughly described for example in the European Patent publications EP 0774369 B1 and EP 0681932 B2 of the applicant.

In addition to the vehicle weight, twist beam axles also have to absorb forces acting on the wheels during acceleration or deceleration of the vehicle. Thus, particularly when traveling through a curve, lateral forces occur on the wheel contact lines through which the trailing arms, due to the special axle design, can be swiveled about the front bearing points. As is known to the person skilled in the art, twist beam axles for this reason have a tendency toward an oversteer movement when driving through a curve, the so-called “lateral force oversteer.”

In order to counteract the lateral force oversteer, it is known to set the swivel axes of the bearing bushes of the trailing arms typically arranged vertically to the vehicle longitudinal direction obliquely with respect to the vehicle longitudinal direction. Such a twist beam axle is described for example in the European Patent application EP 2020314 A1 and the German Disclosure publication DE 102008035625 A1 of the applicant.

Another solution provides for the use of a Watt's linkage connecting the two trailing arms with each other in vehicle transverse direction. The Watt's linkage comprises rods articulated on the trailing arms and connected with each other via a rocker, wherein the rocker is rotatably mounted on the vehicle body or on the auxiliary frame. A twist beam axle with Watt's linkage generic for the present invention is shown, for example, in the German Disclosure publication DE 102006033755 A1 of the applicant.

In contrast with the foregoing, at least one object of the present invention involves further developing a generic twist beam axle in an advantageous manner. In addition, other objects, desirable features and characteristics will become apparent from the subsequent summary and detailed description, and the appended claims, taken in conjunction with the accompanying drawings and this background.

### SUMMARY

According to an embodiment of the invention, a rear axle of type twist beam axle for a motor vehicle is shown. For the motor vehicle, directions and position relations can be defined in usual terminology like a vehicle longitudinal direction, which extends parallel to a level road between vehicle front and vehicle rear, a vehicle transverse direction, which is arranged parallel to the level road and vertically to the vehicle longitudinal direction as well as a vehicle vertical direction which is arranged perpendicularly both to the vehicle longitudinal as well as to the vehicle transverse direction. A vehicle center plane is arranged parallel to the vehicle longitudinal and vehicle vertical direction and perpendicularly to the vehicle transverse direction.

Generically, the twist beam axle comprises two rigid trailing arms substantially extending in vehicle longitudinal direction and serving for wheel guidance, each of which can be articulated on the vehicle body or a bogie mounted on the vehicle body through a more preferably rotation-symmetrical, for example cylindrical bearing bush. On the two trailing arms a wheel bearing each for the rotatable mounting of a vehicle wheel can be attached. If this is the case, the trailing arms are provided with appropriate fastening sections for example screw flanges.

The two trailing arms are connected with each other through a flexurally strong, yet at least by sections, torsionally soft antiroll bar substantially extending in vehicle transverse direction, which acts as stabilizer. In addition, the two trailing arms are connected with each other through a Watt's linkage substantially extending in vehicle transverse direction, which comprises rods articulated on the trailing arms and connected with each other via a rocker. The two rods are each articulated on the rocker. The rocker itself if rotatably mounted on the vehicle body or a bogie connected with the vehicle body. The Watt's linkage serves as means for transmitting lateral forces from the two trailing arms to the body in order to counteract the lateral force oversteer.

With the twist beam axle according to an embodiment of the invention, the axes of symmetry or center axes of the more preferably rotation-symmetrical, for example cylinder-shaped bearing bushes are each arranged parallel to the vehicle vertical axis. This measure allows a technically particularly simple and cost-effective manufacture of the twist beam axle in industrial series production.

In addition, a number of advantageous effects can be achieved through this measure. With a twist beam axle, the conflict of objectives that the spring rates of the bearing bushes of the trailing arms should be adequately large on the one hand in order to more preferably counteract the lateral force oversteer, but relatively low in order to offer appropriate ride comfort on the other hand has to be solved as a matter of principal. Since with twist beam axles with a Watt's linkage the lateral forces acting on the wheels are substantially absorbed by the Watt's linkage, a spring rate more preferably in vehicle longitudinal direction of the bearing bushes can be reduced. In a particularly advantageous manner, the bearing bushes here have a maximum spring rate of approximately 700 N/mm in vehicle longitudinal direction each, so that the twist beam axle offers relatively high ride comfort more preferably when driving over objects such as transverse joints and the like. In order to ensure adequate durability of the bearing bushes it can be more preferably an advantage if the bearing bushes each have a spring rate in vehicle longitudinal direction in the range from approximately 400 N/mm to approximately 700 N/mm.

With a configuration of the twist beam rear axle according to the invention, each bearing bush has spring rates in vehicle longitudinal and vehicle transverse directions that differ from one another. This allows mounting of the bearing bush in installation positions relative to the associated trailing arm which are different from one another and twisted about the axis of symmetry or center axis in order to specifically influence the elastokinematic characteristics of the twist beam axle or match the ride characteristics of the twist beam axle in the desired manner. Here it can be an advantage if each bearing bush has a substantially cylindrical shape and is mounted in a cross-sectionally round bearing eye of the trailing arm in a rotationally fixed and non-sliding manner which makes it possible to optionally arrange the bearing bush in different installation positions twisted about the center axis. For this purpose, the bearing bush can more preferably be pressed into a bearing eye each.

With a further configuration of the twist beam axle according to an embodiment of the invention, the trailing arms are each produced according to the casting method, for example in aluminum, grey cast iron or cast steel methods, which makes possible relatively simple and cost-effective manufacture of the trailing arms in industrial series production.

With an alternate configuration of the twist beam axle according to an embodiment of the invention alternative, the trailing arms are each produced of plates or semi-finished products in form of a welded construction.

The invention furthermore extends to a motor vehicle that is equipped with such a twist beam axle.

### BRIEF DESCRIPTION OF THE DRAWINGS

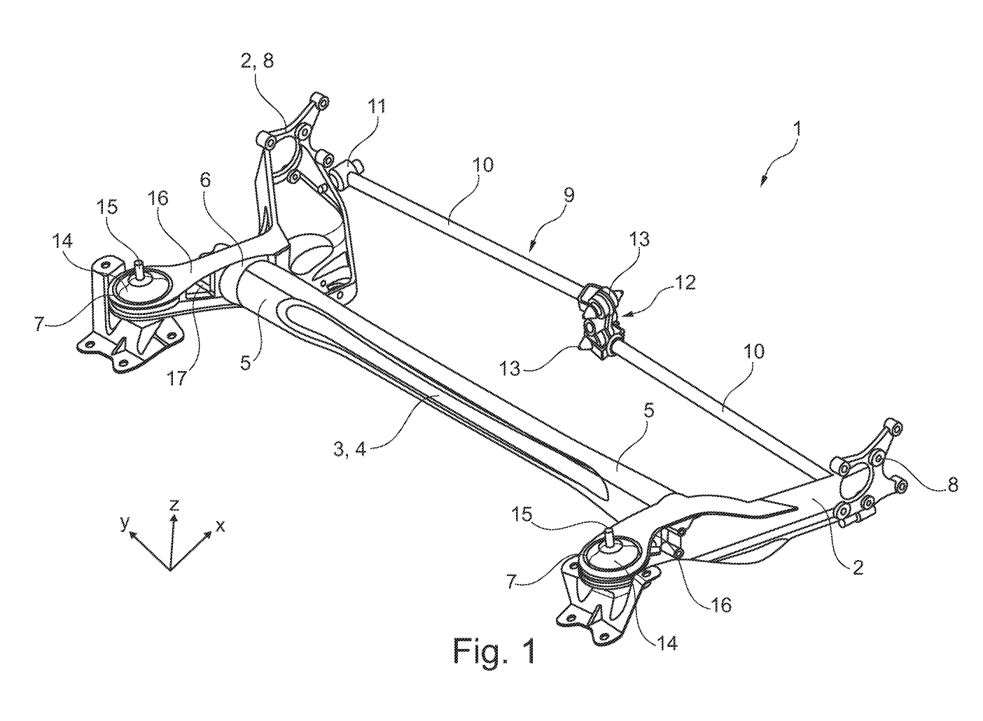

The present invention will hereinafter be described in conjunction with the following FIG. 1 showing a perspective view of an exemplary embodiment of the rear axle of type twist beam axle according to the invention for a motor vehicle (“twist beam axle”).

### DETAILED DESCRIPTION

The following detailed description is merely exemplary in nature and is not intended to limit application and uses. Furthermore, there is no intention to be bound by any theory presented in the preceding background or summary or the following detailed description.

In FIG. 1, directional details relating to the motor vehicle are stated according to a state installed in the motor vehicle of the twist beam axle as a whole designated with the reference number 1. In conventional notation “x” corresponds to the vehicle longitudinal direction, which in this case is directed from the vehicle front to the vehicle rear for example, “y” to the vehicle transverse direction and “z” to the vehicle vertical direction.

Accordingly, the twist beam axle 1 comprises two wheel-guiding, rigid trailing arms 2 that are connected with each other through a flexurally stiff but torsionally elastic transverse profile 3. The two trailing arms 2 extend in vehicle longitudinal direction (x). The transverse profile 3 extends in vehicle transverse direction (y) and acts as stabilizer during the mirror-inverted spring bump and rebound of the vehicle wheels carried by the twist beam axle 1. Although this is not shown, the stabilizer effect of the transverse profile 3 can be reinforced through an additional stabilizer.

The transverse profile 3 connecting the two trailing arms 2 with each other comprises an intermediate section 4 that is profiled U-shaped in cross section and can be torsioned about its extension direction through which the two tubular end sections 5 are connected with each other. Through the position of the opening of the U-profile the roll center of the twist beam axle 1 can be influenced in order to achieve a desirable rolling or swaying behavior of the motor vehicle. The transverse profile 3 is produced for example of a hollow cylindrical tube by means of press forming, and the tube is pressed into a press dye by means of a pressing ram in order to profile the intermediate section 4 U-shaped. The tube can for example be produced of steel plate and have a diameter of approximately 100 mm and a wall thickness of approximately 3.0 mm.

The U-shaped profiling of the transverse profile 3 must merely be considered as an example. It would also be conceivable to provide the intermediate section 4 of the transverse profile 3 with another profile, for example a V- or X-shaped profile. In addition, the transverse profile 3 can comprise an offset in vehicle vertical direction (z) in order to have more space available on the floor end in the installed state for example for a driveshaft.

At the two end sections 5 the transverse profile 3 is connected with the two trailing arms 2. To this end, an arm shoulder 6 each standing away towards the vehicle center in vehicle transverse direction (y) is molded on to the two trailing arms 2, which arm shoulder here is configured in the shape of a tube socket. The two end sections 5 for example are fastened to the trailing arms through a welded connection which is not shown in more detail. The trailing arms 2 are produced by means of a casting method for example of grey cast iron (cast iron with graphite constituents). It would also be conceivable to produce the trailing arms 2 according to the casting method from aluminum or another light metal material or steel. Likewise the trailing arms 2 can each be produced in form of welded constructions of plate or semi-finished products.

The trailing arms 2 are each provided with a fastening section 8 for fastening a wheel carrier (not shown) for the rotatably mounting of a vehicle wheel. Here, the wheel carriers can be fastened to the respective fastening sections 8 each embodied as flange by fastening screws for example. The two fastening sections 8 are each arranged at the rear of the connecting point of the two end sections 5 of the transverse profile 3.

The two trailing arms 2 are furthermore connected with each other via a Watt's linkage 9 extending in vehicle transverse direction (y). The Watt's linkage 9 comprises two rods 10 which are articulated on the trailing arms 2 in the region of the fastening sections 8 by means of first rod bearings 11. The first rod bearings 11 in this case are embodied as rubber bearing bushes for example with swivel axes extending in vehicle longitudinal direction (x). At the ends facing each other the two rods 10 are each hinged on a rocker 12 via a second rod bearing 13. The second rod bearings 13 in this case are embodied for example as rubber bearing bushes with swivel axes extending in vehicle longitudinal direction (x). They can more preferably be constructed identically to the first rod bearings 11. The rocker 12, which in the unloaded state extends approximately in vehicle vertical direction (z) is rotatably mounted on the vehicle body, if applicable subject to the intermediate connection of a bogie, which is not shown in FIG. 1. Via the Watt's linkage 9, lateral forces, i.e. forces acting in vehicle transverse direction (y) can be transmitted from the two trailing arms 2 to the body, as a result of which the lateral force oversteer can be counteracted.

Each of the two trailing arms 2 is articulated on the vehicle body or a bogie mounted on the vehicle body by way of a bearing bush 14. The bearing bushes 14 for this purpose are pressed into substantially hollow-cylindrical bearing eyes 7 molded for this purpose from the front ends of the trailing arms 2 in a rotationally fixed and non-sliding manner and screwed to the body or bogie via bearing pins 15. The axes of the hollow-cylindrical bearing eyes 7 are arranged parallel to the vehicle vertical direction (z). The two bearing bushes 14 are each designed in fitted form relative to the bearing eyes 7 and thus have a cylindrical outer shape. The bearing pins 15, via which the bearing bushes 14 are screwed to the body or bogie are arranged parallel to an axis of symmetry or center axis (cylinder axis) of the bearing bushes 14. The axis of symmetry or center axis of the bearing bushes 14 is arranged parallel to the vehicle vertical direction (z). The bearing bushes 14 can for example comprise a hollow-cylindrical outer plate, a hollow-cylindrical inner plate and an elastically deformable rubber layer arranged in-between.

The bearing bushes 14 can be optionally pressed into different installation positions twisted about the respective center axes within the bearing eyes 7. The bearing eyes 7 are each formed by two flat bars 16, between which a clearance 17 is cleared for the purpose of weight reduction.

The two bearing bushes 14 make possible swiveling of the trailing arms 2 relative to the vehicle body about swivel axes, each of which is parallel to the vehicle transverse direction (y) or perpendicularly to the vehicle vertical direction (z). In contrast with this, the axes of symmetry or center axes of the bearing bushes 14 (according to the bearing pins 15) are arranged in vehicle vertical direction (z). Thus the swivel axes, about which the trailing arms 2 are swiveled during spring bump and rebound of the vehicle wheels, are each directed perpendicularly to the center axes of the bearing bushes 14.

Through their special configuration, for example through the provision of kidney-shaped clearances in the elastically deformable rubber layer, each bearing bush 14 has spring rates in vehicle longitudinal direction (x) and vehicle transverse direction (y) which are different from one another. This makes it possible to specifically influence the elastokinematic characteristics of the twist beam axle 1 through mere twisting of the installation position of the bearing bushes 14 about their center axes. The bearing bushes 14 for example have a spring rate of approximately 700 N/mm in vehicle longitudinal direction (x).

The trailing arms 2 of the twist beam axle 1 with bearing eyes 7 oriented in vehicle vertical direction (z) and the bearing bushes 14 accommodated therein, can easily be employed also in twist beam axles without Watt's linkage 9. More preferably, trailing arms 2 which are designed identically to one another can be employed on both sides of the twist beam axle with or without Watt's linkage, which reduces the costs for stocking and manufacturing of twist beam axles in industrial series production. In such a case, merely bearing bushes 14 with spring rates suitably adapted to a specific configuration of the twist beam axle have to be provided.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A twist beam axle for a motor vehicle, comprising:
two rigid trailing arms for mounting of wheel carriers, each of the two rigid trailing arms adapted to articulate on a vehicle body through bearing bushes; and
a flexurally rigid but at least by sections torsionally elastic antiroll bar connecting the two rigid trailing arms through a Watt's linkage,
wherein center axes of the bearing bushes are arranged substantially parallel to a vehicle vertical axis.

2. The twist beam axle according to claim 1, wherein the bearing bushes each have a maximum spring rate in a vehicle longitudinal direction of approximately 700 N/mm.

3. The twist beam axle according to claim 2, wherein the bearing bushes have a spring rate in the vehicle longitudinal direction in a range from approximately 400 N/mm to approximately 700 N/mm.

4. The twist beam axle according to claim 1, wherein the bearing bushes have spring rates in a vehicle longitudinal direction and a vehicle transverse direction that differ from one another.

5. The twist beam axle according to claim 1, wherein the bearing bushes have a substantially cylindrical shape and each is mounted in a cross-sectionally round bearing eye of the two rigid trailing arms in a rotationally fixed and non-sliding manner.

6. The twist beam axle according to claim 5, wherein the bearing bushes are each pressed into a bearing eye.

7. The twist beam axle according to claim 6, wherein each trailing arm comprises a bar that form the bearing eye.

8. The twist beam axle according to claim 1, wherein the two rigid trailing arms are manufactured according to a casting method.

9. The twist beam axle according to claim 1, wherein the two rigid trailing arms are produced in form of a welded construction.

10. A motor vehicle, comprising:
a vehicle body;
a wheel carrier;
two rigid trailing arms for mounting of the wheel carrier, each of the two rigid trailing arms adapted to articulate on the vehicle body through bearing bushes; and
a flexurally rigid, but at least by sections torsionally elastic antiroll bar connecting the two rigid trailing arms through a Watt's linkage,
wherein center axes of the bearing bushes are arranged substantially parallel to a vehicle vertical axis.

11. The motor vehicle according to claim 10, wherein the bearing bushes each have a maximum spring rate in a vehicle longitudinal direction of approximately 700 N/mm.

12. The motor vehicle according to claim 11, wherein the bearing bushes have a spring rate in the vehicle longitudinal direction in a range from approximately 400 N/mm to approximately 700 N/mm.

13. The motor vehicle according to claim 10, wherein the bearing bushes have spring rates in a vehicle longitudinal direction and a vehicle transverse direction that differ from one another.

14. The motor vehicle according to claim 10, wherein the bearing bushes have a substantially cylindrical shape and each is mounted in a cross-sectionally round bearing eye of the two rigid trailing arms in a rotationally fixed and non-sliding manner.

15. The motor vehicle according to claim 14, wherein the bearing bushes are each pressed into a bearing eye.

16. The motor vehicle according to claim 15, wherein each trailing arm comprises a bar that form the bearing eye.

17. The motor vehicle according to claim 10, wherein the two rigid trailing arms are manufactured according to a casting method.

18. The motor vehicle according to claim 10, wherein the two rigid trailing arms are produced in form of a welded construction.
